(19) United States
(12) Patent Application Publication
(10) Pub. No.: US 2026/0229862 A1
(43) Pub. Date: Aug. 6, 2026

(54) CABLE ORGANIZER FOR CABLE MANAGEMENT

(71) Applicant: Outdoor Wireless Networks LLC, Richardson, TX (US)

(72) Inventors: Marcus Jonathan Ash, Castle Rock, CO (US); Serge Honeysett, Clay, NY (US)

(21) Appl. No.: 19/449,722

(22) Filed: Jan. 15, 2026

Related U.S. Application Data
(60) Provisional application No. 63/753,495, filed on Feb. 4, 2025.

(51) Int. Cl. H02G 3/04

(52) U.S. Cl. CPC H02G 3/0456

(57) ABSTRACT

A cable organizer includes: a floor, first and second side walls that extend from opposite ends of the floor, and a ceiling and a ceiling that form generally a box having an interior, wherein a gap is present in either the ceiling or one of the first and second side walls; and a plurality of fingers extending from the first and second side walls within the interior, wherein each finger has a fixed end and a free end, and wherein the fingers alternately extend from either the first wall or the second wall, thereby defining a path routed from the gap to the floor.

### RELATED APPLICATION

The present application claims priority to and the benefit of U.S. Provisional Patent Application No. 63/753,495, filed February 4, 2025, the disclosure of which is hereby incorporated herein by reference in full.

### FIELD OF THE INVENTION

The present application is directed generally to devices for the organization and management of cables, and in particular telecommunications cables.

### BACKGROUND OF THE INVENTION

Antenna towers and/or tunnels may be crowded due to the large numbers of cables required for signal-carrying. Over time, as systems are added, upgraded and/or expanded, installation of additional cables may be required. Physical organization of the cables can be very helpful, both for a technician installing, replacing, or otherwise servicing the tower and for the reduction of wind loading at the top of the tower.

To conserve space, it may be desirable for each set of cable hangers to secure more than a single cable. Certain cable hangers have been constructed to secure multiple cables; other cable hangers have a stackable construction that permits multiple cable hangers to be interlocked extending outwardly from each mounting point/structural member. Stacked and multiple-cable hangers significantly increase the number of cables mountable to a single attachment point.

One popular stackable cable hanger is discussed in U.S. Patent No. 8,191,836 to Korczak, the disclosure of which is hereby incorporated herein in its entirety. Hangers disclosed therein have generally a U- or C-shaped profile with rounded arms. A locking projection extends from the free end of each arm, and the “root” of the hanger that spans the fixed ends of the arms has a large aperture (typically nominally ¾ inch in diameter), which is the same size as the holes in a typical mounting structure, such as an antenna tower or ladder. The hanger can hold a cable between the arms; gripping of the cable is enhanced by short fingers that extend inwardly from the arms to engage the cable. Hangers can be “stacked” onto each other by inserting the locking projections of one hanger into the large aperture of the next hanger. Modified versions of these hangers are discussed in U.S. Patent No. 9,866,004 to Vaccaro, hereby incorporated herein by reference in full; these arrangements may be more desirable for fiber optic and hybrid cables, which tend to be manufactured in a much greater variety of diameters, and which tend to be much heavier than coaxial cables (sometimes as much as three times heavier per unit foot), which induces greater load and stress on the hangers. Additional hanger configurations are discussed in U.S. Patent Nos. 10,253,906; 10,823,312; 10,422,446; and 10,634,265; and U.S. Patent Publication No. 2022/0316622, all of which are hereby incorporated herein by reference in full.

Because more and more cables are now needed at the top of the tower, it may be desirable to provide additional devices for organizing cables.

### SUMMARY

As a first aspect, embodiments of the invention are directed to a cable organizer. The cable organizer comprises: a floor, first and second side walls that extend from opposite ends of the floor, and a ceiling and a ceiling that form generally a box having an interior, wherein a gap is present in either the ceiling or one of the first and second side walls; and a plurality of fingers extending from the first and second side walls within the interior, wherein each finger has a fixed end and a free end, and wherein the fingers alternately extend from either the first wall or the second wall, thereby defining a path routed from the gap to the floor.

As a second aspect, embodiments of the invention are directed to a cable organizer comprising: a floor, first and second side walls that extend from opposite ends of the floor, and a ceiling and a ceiling that form generally a box having an interior, wherein a gap is present between the ceiling and the second side wall; a plurality of fingers extending from the first and second side walls within the interior, wherein each finger has a fixed end and a free end, and wherein the fingers alternately extend from either the first wall or the second wall, thereby defining a path routed from the gap to the floor; and a flange extending from the ceiling into the interior. The cable organizer is formed of a metallic material.

As a third aspect, embodiments of the invention are directed to a cable organizer comprising: a floor, first and second side walls that extend from opposite ends of the floor, and a ceiling and a ceiling that form generally a box having an interior, wherein a gap is present in the ceiling; and a plurality of fingers extending from the first and second side walls within the interior, wherein each finger has a fixed end and a free end, and wherein the fingers alternately extend from either the first wall or the second wall, thereby defining a path routed from the gap to the floor. The cable organizer further comprises a member attached to the ceiling that is configured to move to cover the gap.

### BRIEF DESCRIPTION OF THE FIGURES

FIGS. 1A-1C are side, front and perspective views of a cable organizer according to embodiments of the invention.

FIGS. 2A-2C are side views of the cable organizer of FIGS. 1A-1C showing how cables can be inserted, stored and secured therein.

FIG. 3 is a side view of the cable organizer of FIGS. 1A-1C welded to a horizontal beam of an antenna tower platform.

FIG. 4 is a front view of the cable organizer and beam of FIG. 3 with cables inserted in the cable organizer.

FIG. 5 is a bottom perspective view of an antenna tower platform and antenna illustrating a location that a cable organizer of FIGS. 1A-1C may be mounted to replace prior art cable hangers and adapters.

FIG. 6 is a bottom perspective view of an antenna tower platform and antenna illustrating an alternative location that a cable organizer of FIGS. 1A-1C may be mounted to replace prior art cable hangers and adapters.

FIGS. 7A-7E are side, front, perspective, top and bottom views of a cable organizer according to alternative embodiments of the invention.

FIGS. 8A-8C are side views of the cable organizer of FIGS. 7A-7E mounted to a horizontal rectangular beam, a horizontal circular beam, and a vertical pole.

FIG. 9 is a front view of the cable organizer and beam of FIG. 8A with cables inserted in the cable organizer.

FIG. 10A is a side view of a cable organizer according to further embodiments of the invention. FIGS. 10B and 10C are side and perspective view of the cable organizer of FIG. 10A with its slide member in a closed position to retain cables inserted into the cable organizer.

FIGS. 11A and 11B are side and rear views of a cable organizer according to still further embodiments of the invention. FIGS. 11C and 11D are side and perspective views showing the ceiling locked into place to retain cables inserted into the cable organizer.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout and different embodiments of like elements can be designated using a different number of superscript indicator apostrophes (e.g., 10', 10'', 10''') or using different letters in conjunction with the same base reference number (e.g., 10a, 10b, 10c).

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms "a", "an" and "the" are intended to include the plural forms as well, unless the context clearly indicates otherwise. It will be further understood that the terms "comprises" and/or "comprising", when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items.

As used herein, phrases such as "between X and Y" and "between about X and Y" should be interpreted to include X and Y. As used herein, phrases such as "between about X and Y" mean "between about X and about Y." As used herein, phrases such as "from about X to Y" mean "from about X to about Y."

It is noted that aspects of the invention described with respect to one embodiment, may be incorporated in a different embodiment although not specifically described relative thereto. That is, all embodiments and/or features of any embodiment can be combined in any way and/or combination. Objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

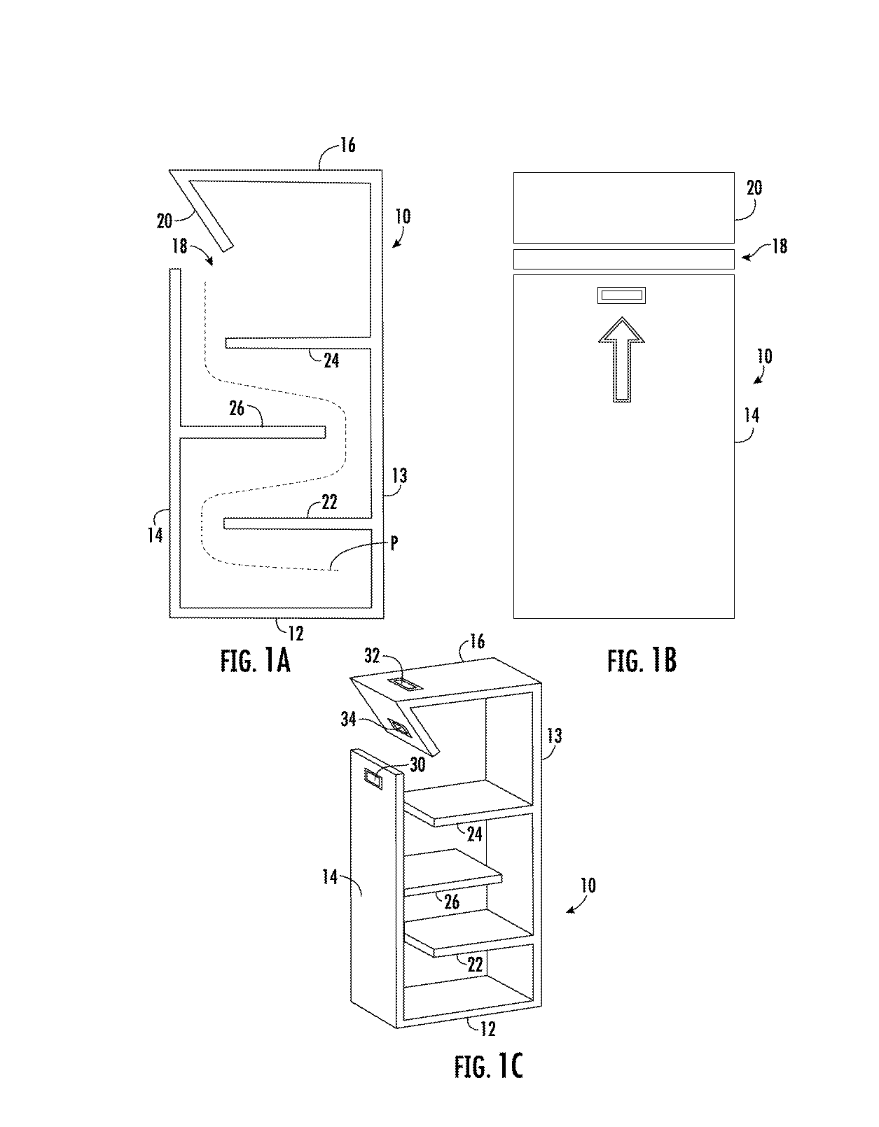

Referring now to the drawings, a cable organizer, designated broadly at 10, is shown in FIGS. 1A-1C. The cable organizer 10 is generally box-shaped, with a floor 12, opposing side walls 13, 14, and a ceiling 16. The side wall 14 does not merge with the ceiling 16, but stops short of the ceiling 16, such that a gap 18 is formed therebetween. A flange 20 extends downwardly from the end of the ceiling and extends into the interior of the cable organizer 10.

Two fingers 22, 24 extend from the side wall 13 into the interior, and one finger 26 extends into the interior from the side wall 14, with the finger 26 sandwiched between the fingers 22, 24. In each instance the fingers 22, 24, 26 do not extend to the opposite side wall 13, 14, but instead form a gap with the side wall. As a result, a serpentine path P is defined within the interior space of the cable organizer 10.

Referring to FIG. 1C, it can be seen that each of the side wall 14, the ceiling 16 and the flange 20 includes a respective horizontal slot 30, 32, 34.

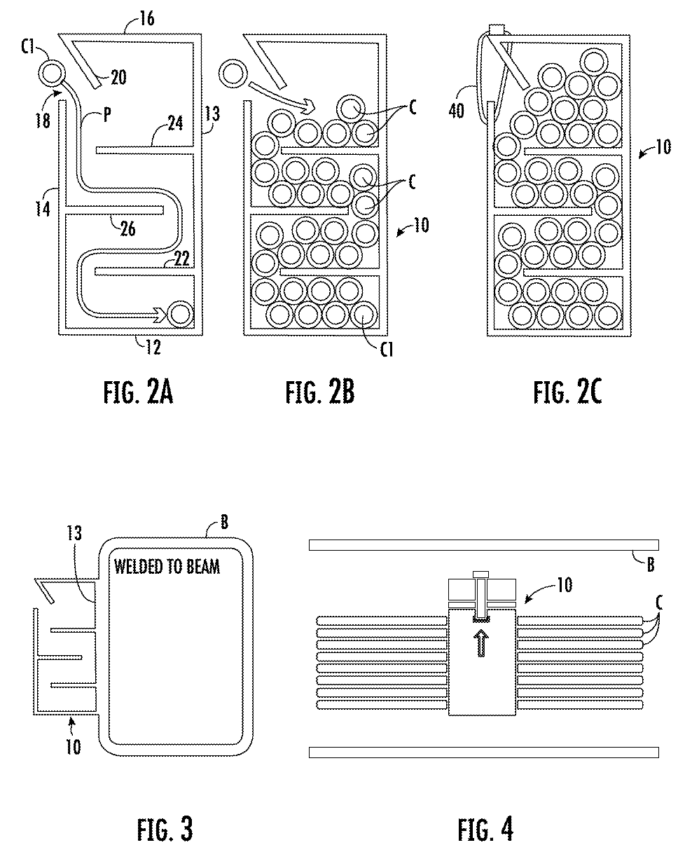

FIGS. 2A-2C illustrate how the cable organizer can be employed to organize a large number of individual cables. FIG. 2A shows the insertion of a cable C1 through the gap 18 between the flange 20 and the upper end of the side wall 14. The cable C1 can be routed along the serpentine path P defined by the fingers 22, 24, 26 and the side walls 13, 14 until it reaches the lower end of the path P at the intersection of the floor 12 and the side wall 13. FIG. 2B illustrates that additional cables C can be inserted and similarly routed, each stopping when it reaches cables that have already been inserted and collected along the path P. FIG. 2C illustrates that, once the cable organizer 10 has received all of the cables intended for organization, a cable tie 40 can be inserted through the slots 30, 32, 34 and interconnected, with the result that the gap 18 is blocked so that no cables C can escape.

The cable organizer 10 can be of dimensions that are suitable for receiving and capturing cables. In some embodiments, the cable organizer 10 is between about 6 and 12 inches in height (i.e., from ceiling 16 to floor 12) and/or between about 3 and 6 inches in width (i.e., between the side walls 13, 14). Generally speaking, the gap 18 may be between about 0.5 and 1 inch to allow the insertion of the largest-sized cable anticipated to be captured. Similarly, the serpentine path P may be between about 1 and 1.5 inches in height to allow for the capture of large cable sizes. In some embodiments, surfaces that may contact cables (e.g., the edges and free ends of the fingers 22, 24, 26, the free end of the flange 20, etc.) may be beveled to encourage the entry of cables, and may be smoothed to remove any burrs or sharp edges that might damage the cables.

The cable organizer 10 is formed of a metallic material such as steel. As such, it can be welded onto a steel beam B, with the side wall 13 abutting the beam B. Once the cable organizer has been welded into place (FIG. 3), the cable organizer 10 can then be filled with cables C (see FIG. 4).

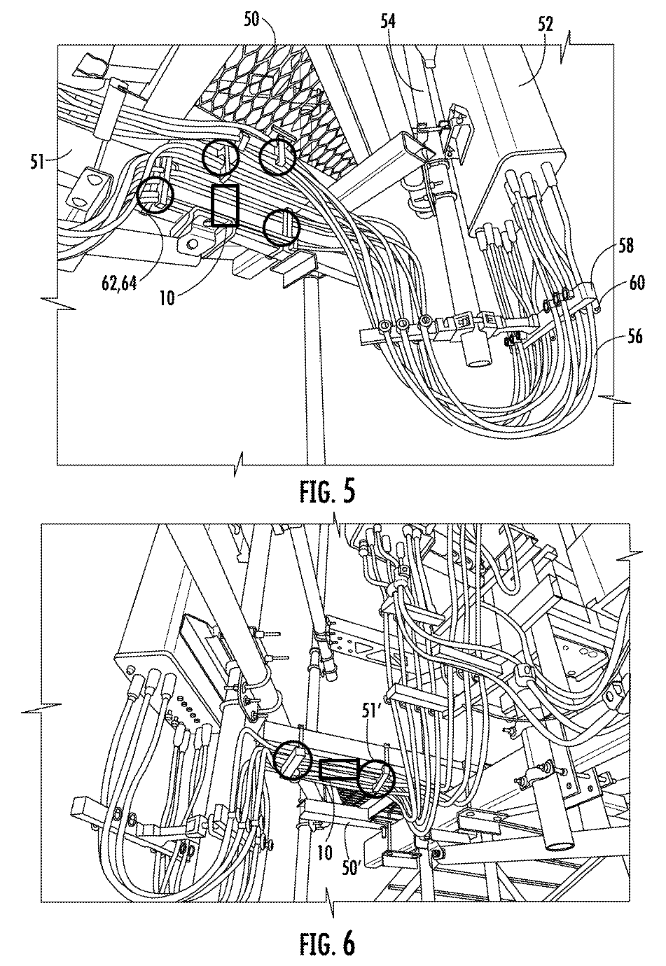

FIG. 5 illustrates a circumstance in which the cable organizer 10 may be employed. FIG. 5 shows a portion of a platform 50 that is mounted at the top of a telecommunications tower. An antenna 52 is mounted on a vertical pole 54 that is in turn mounted to the platform 50. Many cables 56 exit the lower end of the antenna 52 and are routed underneath the platform 50. In addition to the cable hangers 58 and adapters 60 that are mounted on the lower end of the pole 54, at several locations various adapters 62 are mounted to locations beneath the platform 50, and in each instance stackable cable hangers 64 are mounted in the adapters 62 to capture ad organize the cables. All of the adapters 62 and cable hangers 64 shown in FIG. 5 (denoted with red circles) could be replaced with a single cable organizer 10 (denoted with a green rectangle) mounted onto the side surface of a beam 51 of the platform 50, as the cable organizer 10 could capture and organize all of the cables into a single location. This arrangement can significantly decrease the amount of time a technician is forced to spend at the top of the tower organizing the cables 56. Another exemplary environment is shown in FIG. 6, wherein a cable organizer 10 may be mounted on the lower surface of a beam 51’ of a platform 50’.

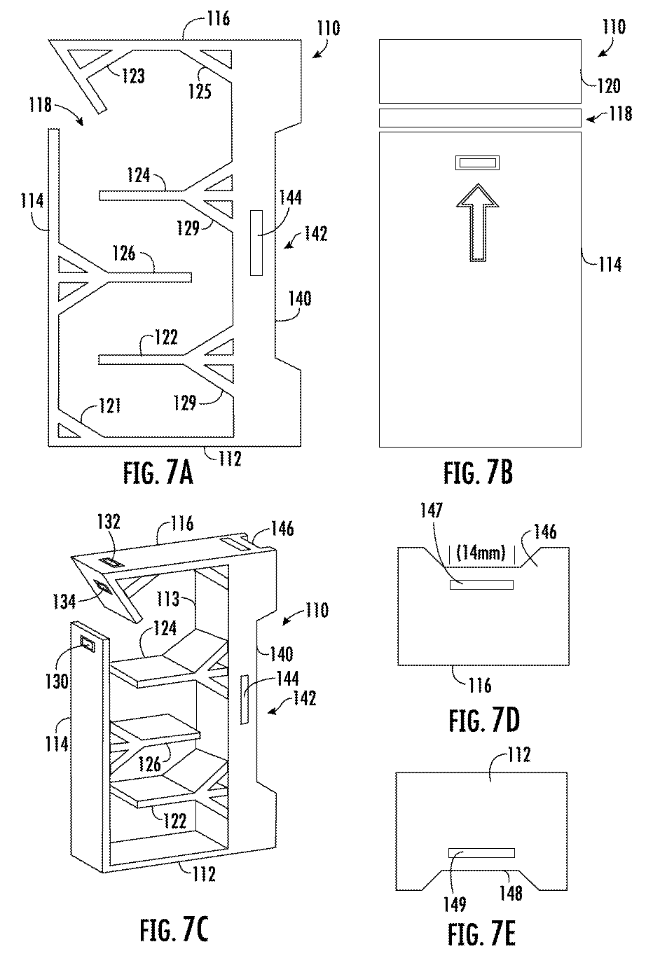

Although the cable organizer 10 is proposed to be formed of steel, other embodiments may be formed of other materials, such as polymeric materials like acetal. An alternative embodiment of a cable organizer is illustrated in FIGS. 7A-7E and is designated broadly at 110. The cable organizer 110 is similar to the cable organizer 10 in that it has a floor 112, opposing side walls 113, 114, a ceiling 116, and a flange 120 that are similar to the analogous structures of the cable organizer 10. The side wall 114, the ceiling 116, and the flange 120 have slots 130, 132, 134 that can receive a cable tie (such as that shown at 40 in FIG. 4 above) to close the gap 118 and thereby prevent unwanted escape of cables inserted into the cable organizer 110.

The cable organizer 110 also has fingers 122, 124, 126 that extend from the side walls 113, 114 to form a serpentine path S2. However, because the cable organizer 110 is formed of a polymeric material, each of the fingers 122, 124, 126 is supported at its base by ribs or gussets 129. Additionally, the joints between (a) the side wall 114 and the floor 112, (b) the ceiling 116 and the flange 120, and (c) the ceiling 116 and the side wall 113 are buttressed by gussets 121, 123, 125, respectively.

Further, the cable organizer 110 includes extender walls 140 that extend away from each of the side edges of the side wall 114. Each of the extender walls 140 has a recess 142. A vertical slot 144 is present adjacent the recess 142. Also, top and bottom bridges 146, 148 span the upper and lower ends of the extender walls 140. Slots 147, 149 are present in, respectively, the top and bottom bridges 146, 148.

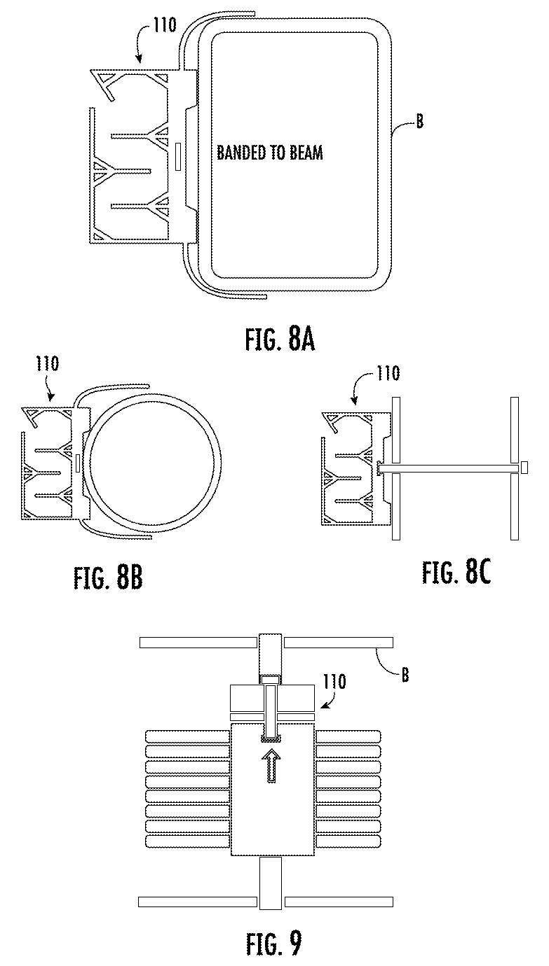

As shown in FIGS. 8A-8C, the cable organizer 110 can be attached to a horizontal structure (such as a beam B of a cell tower platform) that is of rectangular cross-section (FIG. 8A) or of circular cross-section (FIG. 8B) by routing a flexible band through the slots 147, 149 and around the structure. Alternatively, the cable organizer 110 can be attached to a vertical structure by routing a flexible band through the slots 144 (FIG. 8C). Thus, the cable organizer 110 can be easily mounted to horizontal or vertical structures as desired for organizing cables (see FIG. 9 as an example of mounting the cable organizer 110 to a horizontal beam with cables captured therein).

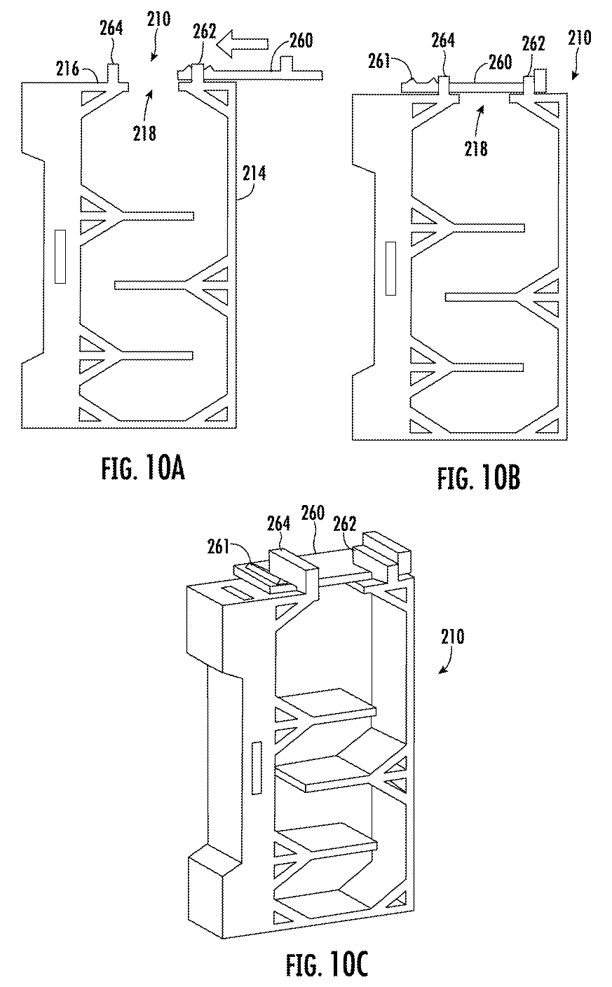

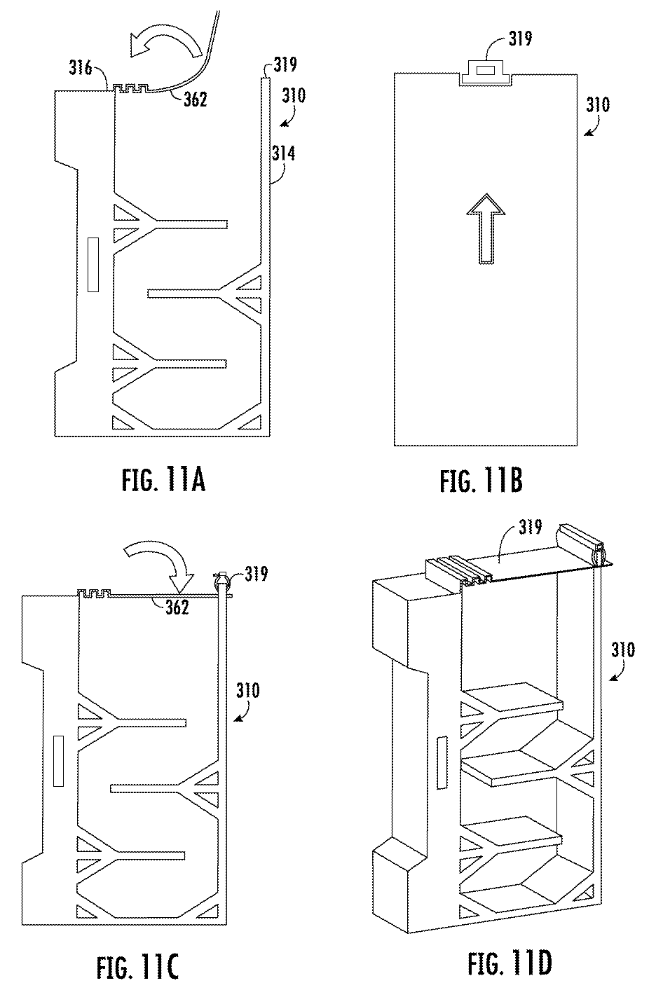

Further embodiments of cable organizers are shown in FIGS. 10A-10C and in FIGS. 11A-11D. A cable organizer shown in FIGS. 10A-10C is designated at 210 and is similar to the cable organizer 110 discussed above, but it lacks a flange extending downwardly into interior, the side wall 214 extends upward to the ceiling 216, and the ceiling 216 includes a gap 218 for receiving the cables. A sliding member 260 is mounted within a slide bearing 262 attached to the upper surface of the ceiling 216 on one side of the gap 218. A capture loop 264 is mounted to the ceiling on the opposite side of the gap 218. Once cables are loaded into the cable organizer 210, the slide member 260 can be slid within the slide bearing 262 to the capture loop 264, which captures a hook 261 on the slide member 260. This action covers the gap 218 and prevents cables within the cable organizer 210 from escaping.

FIGS. 11A-11D illustrate a cable organizer 310 that is similar to the cable organizer 210, but the ceiling 316 includes is formed by a flexible sheet 362 that is fixed to the side wall 313 and cantilevers away the side wall 313. The side wall 314 has a receptacle 319 for the free end of the ceiling 316. Thus, when the cable organizer 310 is filled with cables, the free end of the flexible sheet 318 can be locked into the receptacle 319 to cover the gap 318 and maintain the cables in place.

Those of skill in this art will appreciate that members other than the sliding member 26n the sliding member 260 and the flexible sheet 318 may be employed to cover the gap in the ceiling 316.

It will be understood that the discussion of dimensions, sizes, etc. directed to the cable organizer 10 is equally applicable to the cable organizers 110, 210, 310.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed is:

1. A cable organizer, comprising:
a floor, first and second side walls that extend from opposite ends of the floor, and a ceiling and a ceiling that form generally a box having an interior, wherein a gap is present in either the ceiling or one of the first and second side walls; and
a plurality of fingers extending from the first and second side walls within the interior, wherein each finger has a fixed end and a free end, and wherein the fingers alternately extend from either the first wall or the second wall, thereby defining a path routed from the gap to the floor.

2. The cable organizer defined in claim 1, wherein the gap is present between the second side wall and the ceiling.

3. The cable organizer defined in claim 2, further comprising a flange extending from the ceiling into the interior.

4. The cable organizer defined in claim 3, wherein the flange, the second side wall, and the ceiling include respective slots.

5. The cable organizer defined in claim 2, formed of a metallic material.

6. The cable organizer defined in claim 5, wherein the first side wall is substantially planar.

7. The cable organizer defined in claim 1, further comprising at least two extender walls extending from the first wall away from the interior.

8. The cable organizer defined in claim 7, wherein each of the at least one extender walls has a recess.

9. The cable organizer defined in claim 7, wherein each of the extender walls has a vertical slot.

10. The cable organizer defined in claim 7, further comprising top and bottom bridges that extend between the at least two extender walls.

11. The cable organizer defined in claim 10, wherein a slot is present in each of the top and bottom bridges.

12. The cable organizer defined in claim 1, wherein the gap is present in the ceiling.

13. The cable organizer defined in claim 12, further comprising a sliding member mounted to the ceiling that is configured to slide to close the gap.

14. The cable organizer defined in claim 12, wherein the ceiling is flexible and is configured to engage a locking feature to selectively close the gap.

15. The cable organizer defined in claim 1, formed of a polymeric material.

16. The cable organizer defined in claim 1, mounted to a beam of an antenna platform.

17. The cable organizer defined in clam 1, in combination with a plurality of cables inserted along the path.

18. A cable organizer, comprising:
a floor, first and second side walls that extend from opposite ends of the floor, and a ceiling and a ceiling that form generally a box having an interior, wherein a gap is present between the ceiling and the second side wall;
a plurality of fingers extending from the first and second side walls within the interior, wherein each finger has a fixed end and a free end, and wherein the fingers alternately extend from either the first wall or the second wall, thereby defining a path routed from the gap to the floor; and
a flange extending from the ceiling into the interior;
wherein the cable organizer is formed of a metallic material.

19. The cable organizer defined in claim 18, wherein the flange, the second side wall, and the ceiling include respective slots.

20. A cable organizer, comprising:
a floor, first and second side walls that extend from opposite ends of the floor, and a ceiling and a ceiling that form generally a box having an interior, wherein a gap is present in the ceiling; and
a plurality of fingers extending from the first and second side walls within the interior, wherein each finger has a fixed end and a free end, and wherein the fingers alternately extend from either the first wall or the second wall, thereby defining a path routed from the gap to the floor;
wherein the cable organizer further comprises a member attached to the ceiling that is configured to move to cover the gap.
